(19) United States
(12) Patent Application Publication
(10) Pub. No.: US 2001/0013088 A1
(43) Pub. Date: Aug. 9, 2001

(54) Information providing system, information providing method, and client apparatus

(75) Inventor: Hidehiro Matsumoto, Tokyo (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION.

(21) Appl. No.: 09/777,882

(22) Filed: Feb. 7, 2001

(30) Foreign Application Priority Data
Feb. 9, 2000 (JP) 031643/2000

(51) Int. Cl. G06F 13/16; G06F 12/12

(52) U.S. Cl. 711/135; 711/138; 709/203

(57) ABSTRACT

A client apparatus (20) requesting acquirement of various information stored in an information source server (21) receives, through a GW apparatus (23), the information from the information source server (21) transiently stored in a cache memory (25) by an agent program (28) of the GW apparatus (23), in accordance with profile information of the client apparatus (20), preference information of its user and communication attribute information of a data communication network (22, 24), while effectively using the data communication network (22, 24). The client apparatus (20) stores the reception information from the GW apparatus (23) in a cache memory (26), in accordance with attribute information (27), and re-configures the information accumulated in the cache memory (26) for each access by considering the relation to the stored information. Thus, it is possible to provide an information providing system and an information providing method, which can attain the effective communication in conjunction with the acquirement of the information provided by the information source server (21) to the client apparatus (20) having a low process ability, and a client apparatus (20) that can effectively acquire the various information provided by the information source server (21) even in the case of the low process ability.

### BACKGROUND OF THE INVENTION

1. Field of the Invention

The present invention relates to an information providing system and an information providing method for acquiring various information provided by an information source server through a data communication network, and a client apparatus (hereafter simply referred to as “client”) for acquiring the various information provided by the information source server.

2. Description of the Related Art

Associated with the developments of an information processing technique and a communication technique, a client such as a computer terminal mounted in a typical house or an office or the like can easily read the information stored in an information source server installed on the Internet through which various computer networks are connected to each other. In particular, a portable information apparatus such as an information terminal, a portable telephone, a personal handy-phone system (hereafter, abbreviated as PHS) or the like can carry out a wireless data communication as a client to thereby access the information. A popularization of this portable information apparatus is remarkable. The access to the information source server that stores therein the various information and uses the portable information apparatus as the client on the Internet is conventionally done through a gateway (hereafter, referred to as “GW”).

FIG. 1 shows an example of a configuration of a conventional information providing system, in order that a client 10 acquires information provided by an information source server 11 through a gateway apparatus. The client 10 such as a wireless portable terminal in the conventional information providing system and the like uses a GW apparatus 13 connected through a data communication network 12 through which a wire or wireless data communication with this information source server 11 can be done, in order to acquire various information stored in the information source server 11 connected to the Internet. The client 10 is connected to this GW apparatus 13 through a data communication network 14 through which the wire or wireless data communication can be done.

In order to absorb differences of a security manner of communication data, a band width and a transmission delay amount between the data communication network 12 and the data communication network 14 and reduce a load on the data communication network 12 as much as possible, the GW apparatus 13 has a cache memory 15, and transiently accumulates therein the information from the information source server 11 to which the client 10 requests an access. That is, the GW apparatus 13, when receiving an information access request from the client 10 through the data communication network 14, acquires necessary information from the information source server 11, and converts it into a packet, and transiently accumulates in the cache memory 15. Accordingly, when the client 10 again issues the information access request to the same information source server 11, the GW apparatus 13 transfers the necessary information accumulated in the cache memory 15 to the client 10 without any connection to the information source server 11. Thus, it is possible to omit a load caused by an unnecessary data communication in the data communication network 12.

However, even in a case of information unnecessary for the client 10 or its user, data is transferred from the information source server 11 through the data communication network 12. Thus, usage efficiencies of the data communication network 12 and the data communication network 14 are dropped. Hence, this results in a useless consumption of a capacity of the cache memory 15 in the GW apparatus 13. So, the following troubles may be induced. For example, such a fact that the client 10 frequently accesses the information accumulated in the same information source server imposes a load on the GW apparatus 13. Or, congestion or overload occurring in the data communication networks 12, 14 disables the information desired by an information provider managing the information source server 11 to be not provided to the client 10 when it must be provided.

So, various techniques are proposed with regard to an information providing system which uses profile information implying attribute information indicative of a display or process ability of the client 10 or preference information implying attribute information indicative of a selection standard or an idea of information necessary for the user of the client 10 and acquires the information necessary for the client 10 or its user at a minimum communication amount.

For example, Japanese Laid Open Patent Application (JP-A-Heisei, 11-55324) entitled “Communication System of Computer Network” discloses a technique with regard to an information providing system intended to effectively use a resource necessary for an information transfer in an entire system in such a way that the agents, which are respectively mounted in advance in an information source server and a GW apparatus and a client, exchange the profile information of various abilities, such as a band width of a data communication network, a size of a display screen and the like, with each other.

Also, Japanese Laid Open Patent Application (JP-A-Heisei, 11-96099) entitled “Service Providing System” discloses a technique with regard to an information providing system, in which preference information composed of a taste of a user using a client, a usage history and the like is stored in a GW apparatus, and the GW apparatus, when receiving an information access request from the client, determines information to be provided to the client, in accordance with this preference information.

However, the technique disclosed in Japanese Laid Open Patent Application (JP-A-Heisei, 11-55324) has the following problem. That is, it can attain a dispersion of a load and an increase in an efficiency of the communication in the entire system due to a linkage process between the agents mounted in each of the information source server, the GW apparatus and the client. However, its application is difficult when the client is a portable terminal in which a miniaturization is required and a high process ability can not be desired, such as a portable telephone and PHS that are remarkably popularized in recent years. That is, a client having a low process ability owes a load caused by a linkage process between the agents and a communication process with the GW apparatus 13. Moreover, this is inconvenient for the user using the client from the viewpoint of a communication cost.

Also, the technique disclosed in Japanese Laid Open Patent Application (JP-A-Heisei, 11-96099) has the following problem. That is, it can attain an increase in an efficiency of the communication in the entire system by improving the probability in the taste of the information required by the user using the client in the GW apparatus. However, a communication process amount is not dropped so much between the client and the GW apparatus. Similarly, the client having the low process ability has the problem from the viewpoint of the process load and the communication cost.

When the client having the low process ability carries out a mobile communication, under a handoff control of a higher rank station managing the client, it is necessary to read a content of an accessed information source server as quickly as possible and remove an unnecessary electronic mail and content. However, a process load associated with a communication process with the GW apparatus and the like causes a throughput of the mobile communication to be remarkably reduced.

### SUMMARY OF THE INVENTION

Therefore, an object of the present invention is to provide an information providing system and an information providing method, which can attain an increase in an efficiency of communication in conjunction with acquirement of information which is provided from an information source server to a client apparatus having a low process ability, and provide the client apparatus that can effectively acquire various information provided by the information source server even in the case of the low process ability.

To accomplish the above object, according to a first aspect of the present invention, there is provided a client apparatus, which includes a cache memory, an accumulation judgment portion, a request portion, a storage judgment portion and a control portion.

The cache memory accumulates information externally provided. The accumulation judgment portion judges whether or not the information to be externally provided is accumulated in the cache memory. The request portion requests acquirement of information when the accumulation judgment portion judges that the information to be externally provided is not accumulated in the cache memory. The information processor, which processes either, one of the information accumulated in the cache memory and the information externally provided in response to the request from the request portion. The storage judgment portion judges whether or not the information externally provided can be stored in the cache memory. The information reduction portion reduces an amount of the information accumulated in the cache memory based on attribute information composed of preference information indicative of a user and profile information indicative of a process ability of the client apparatus when the storage judgment portion judges that the information externally provided can not be stored in the cache memory. The control portion controls the cache memory such that the information externally provided in response to the request from the request portion is stored after the information reduction portion reduces the amount of the information.

In the first aspect of the present invention, the cache memory for accumulating the information therein provided from the information source server is equipped. If the acquirement of the information is requested to the information source server, the accumulation judgment portion judges whether or not the information whose acquirement is requested is accumulated in the cache memory. If it is judged that the information is not accumulated, the acquirement is firstly requested to the information source server. The control portion controls the cache memory such that the correspondingly acquired information in the cache memory is stored therein after an increase of a remaining capacity of the cache memory, based on the attribute information composed of the preference information of the user and the profile information indicative of its process ability and the like.

To accomplish the above object, according to a second aspect of the present invention, there is provided an information providing system, which includes an information source server which provides information in response to a request, the client apparatus according to the first aspect of the present invention and a data communication network which connects the client apparatus to the information source server.

In the above client apparatus, the cache memory accumulates the information provided by the information source server. The accumulation judgment portion judges whether or not the information to be provided by the information source server is accumulated in the cache memory. The request portion requests acquirement of the information to the information source server through the data communication network when the accumulation judgment portion judges that the information to be provided by the information source server is not accumulated. The information processor processes either one of the information accumulated in the cache memory and the information provided by the information source server in response to the request from the request portion. Also, the storage judgment portion judges whether or not the information provided by the information source server can be stored in the cache memory. The information reduction portion reduces the amount of the information accumulated in the cache memory based on attribute information composed of preference information of a user and profile information indicative of a process ability of the client apparatus when the storage judgment portion judges that the information provided by the information source server can not be stored in the cache memory. The control portion controls the cache memory such that the information provided by the information source server in response to the request from the request portion is stored after the information reduction portion reduces the amount of the information.

In the second aspect of the present invention, the information providing system includes the information source server for providing the information and the client apparatus for requesting the acquirement of the information to this information source server. In the client apparatus, the cache memory for accumulating the acquirement information from the information source server is provided. So, if the acquirement of the information is requested to the information source server, the accumulation judgment portion judges the presence or absence of the accumulation of the information whose acquirement is requested to the cache memory. If it is judged that the information is accumulated, the information process is performed on this accumulated information. On the other hand, if the accumulation judgment portion judges that the information whose acquirement is requested is not accumulated in the cache memory, the acquirement is firstly requested through the data communication network to the information source server. Then, if the information is acquired correspondingly to this acquirement request, the information process is performed on this information. Under controlling of the control portion, an information newly acquired from the information source server is stored in the cache memory after reducing the amount of the information provided by the information source server and accumulated in the cache memory based on the attribute information composed of the preference information of the user and the profile information indicative of its process ability and the like and increasing a remaining amount of the cache memory.

In this information providing system according to second aspect of the present invention, the data communication network may be composed of a gateway apparatus which is connected to the client apparatus through a first data communication network and connected to the information source server through a second data communication network.

In this case, the gateway apparatus may include a second request portion, a second cache memory and a transfer portion. The second request portion requests acquirement of the information to the information source server through the second data communication network with the attribute information and communication attribute information indicative of communication abilities of the first data communication network and the second data communication network when the request of the request portion of the client apparatus is received through the first data communication network. The second cache memory accumulates the information provided by the information source server in response to the request from the second request portion. The transfer portion, which transfers the information accumulated in the second cache memory to the client apparatus through the first data communication network based on the attribute information and the communication attribute information.

In this information providing system, the gateway apparatus is inserted between the client apparatus and the information source server so that the information can be sent and received through the first data communication network and the second data communication network, respectively. This gateway apparatus once receives the acquirement request of the information to the information source server from the client apparatus, then, the second request portion requests the acquirement of the information whose acquirement is requested to the information source server, based on the attribute information and the communication attribute information indicative of the communication abilities of the first data communication network and the second data communication network. So, if the information is acquired from the information source server in response to this acquirement request, it is accumulated in the second cache memory. Moreover, the information accumulated in the second cache memory is transferred through the first data communication network to the client apparatus, based on the attribute information and the communication attribute information.

To accomplish the above object, according to a third aspect of the present invention, there is provided an information providing method, which includes the steps of (1) providing an information source server and a client apparatus, (2) accumulating information provided by the information source server in a cache memory, (3) judging whether or not the information to be provided by the information source server is accumulated in the cache memory, (4) requesting acquirement of the information to the information source server when the judging step (3) judges that the information to be provided by the information source server is not accumulated in the cache memory, and (5) processing either one of the information accumulated in the cache memory and the information provided by the information source server in response to the request.

This third aspect of the present invention may further include the steps of (6) judging whether or not the information provided by the information source server can be stored in the cache memory, (7) reducing the amount of the information accumulated in the cache memory based on attribute information composed of preference information of a user and profile information indicative of a process ability of the client apparatus when the judging step (6) judges that the information provided by the information source server can not be stored in the cache memory and (8) controlling the cache memory such that the information provided by the information source server in response to the request is stored after the amount of the information is reduced by the reducing step.

In the third aspect of the present invention, it is judged whether or not the information whose acquirement is requested to the information source server from the client apparatus is accumulated in the cache memory for accumulating therein the information already acquired from the information source server in advance. If it is judged that the information is not accumulated, the acquirement of the information is requested through the data communication network to the information source server. So, the information source server provides the information whose acquirement is requested. In accordance with the attribute information composed of the preference information of the user and the profile information indicative of its process ability and the like, the client apparatus increases a remaining capacity of the cache memory, and then stores the information provided by the information source server in the cache memory.

This third aspect of the present invention may further include the steps of (9) providing a gateway apparatus which is connected to the client apparatus through a first data communication network and connected to the information source server through a second data communication network, (10) requesting acquirement of the information to the information source server through the second data communication network with the attribute information and communication attribute information indicative of communication abilities of the first data communication network and the second data communication network when the request of the requesting step (4) is received through the first data communication network, (11) accumulating the information provided by the information source server into a second cache memory in response to the request in the requesting step (10) and (12) transferring the information accumulated in the second cache memory to the client apparatus through the first data communication network based on the attribute information and the communication attribute information.

In the third aspect of the present invention, it is judged whether or not the information whose acquirement is requested to the information source server from the client apparatus is accumulated in the cache memory for accumulating therein the already acquired information provided by the information source server in advance. If it is judged that the information is not accumulated, the acquirement of the information is requested through the first data communication network to the information source server. The gateway apparatus receives the acquirement request. In accordance with the attribute information composed of the preference information of the user and the profile information indicative of the process ability of the client apparatus and the like and the communication attribute information indicative of the communication abilities of the first data communication network and the second data communication network to the information source server, this gateway apparatus requests the acquirement of the information whose acquirement is requested by the client apparatus through the second data communication network to the information source server. The information source server provides the information whose acquirement is requested. The gateway apparatus accumulates therein this provided information. Moreover, the gateway apparatus transfers this accumulated information through the first data communication network to the client apparatus based on the attribute information and the communication attribute information. The client apparatus increases a remaining capacity of the cache memory, based on the attribute information, and then stores the information provided by the information source server in the cache memory.

### BRIEF DESCRIPTION OF THE DRAWINGS

FIG. 1 is a configuration view showing an example of a configuration of a conventionally proposed information providing system;

FIG. 2 is a configuration view showing a schematic configuration of an information providing system according to a first embodiment of the present invention;

FIG. 3 is a sequence diagram schematically showing a series of information acquiring sequences of the information providing system according to the first embodiment of the present invention;

FIG. 4 is an explanation view showing a schematic configuration of memory information in a cache memory of a client in the first embodiment of the present invention;

FIG. 5 is a flowchart showing an example of a process content of an information source server access process of the client in the first embodiment of the present invention;

FIG. 6 is an explanation view conceptually showing a manner when information received from the information source server is accumulated in the cache memory of the client in the first embodiment of the present invention;

FIGS. 7A to 7C are explanation views showing examples of a screen image displayed on a display of the client in the first embodiment of the present invention;

FIG. 8 is a flowchart showing an example of a process for reconfiguring the memory information in the cache memory of the client in the first embodiment of the present invention;

FIG. 9 is an explanation view conceptually showing an example of a manner when the information received from the information source server is stored in the cache memory of the client in the first embodiment of the present invention;

FIG. 10 is an explanation view conceptually showing another example of the manner when the information received from the information source server is stored in the cache memory of the client in the first embodiment of the present invention;

FIG. 11 is an explanation view conceptually showing an example of a manner when the information received from the information source server is compressed in the cache memory of the client in the first embodiment of the present invention; and

FIG. 12 is a configuration view showing a schematic configuration of an information providing system in a second embodiment of the present invention.

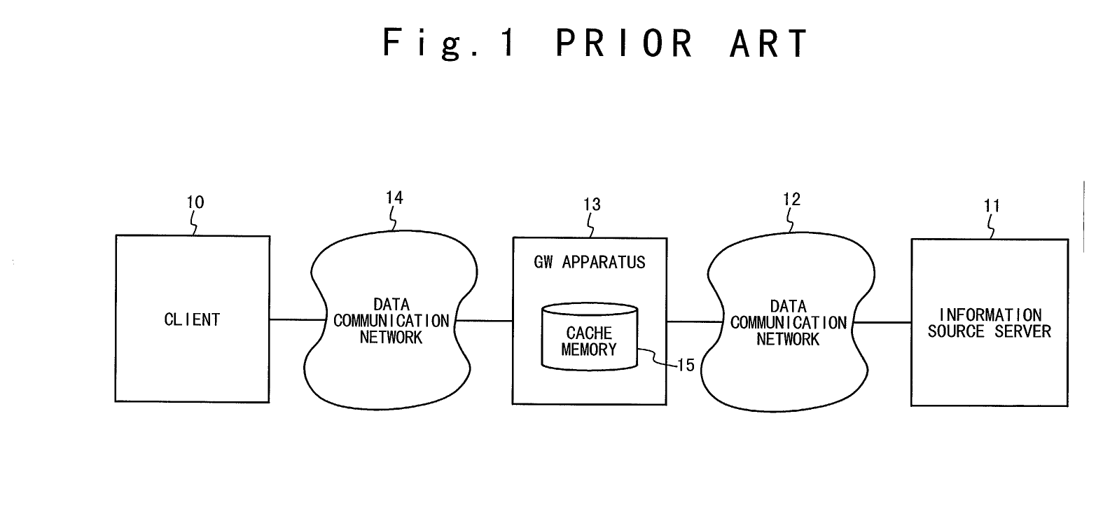

### DESCRIPTION OF THE PREFERRED EMBODIMENT

An information providing system, an information providing method and a client according to embodiments of the present invention will be described below with reference to drawings.

(First Embodiment)

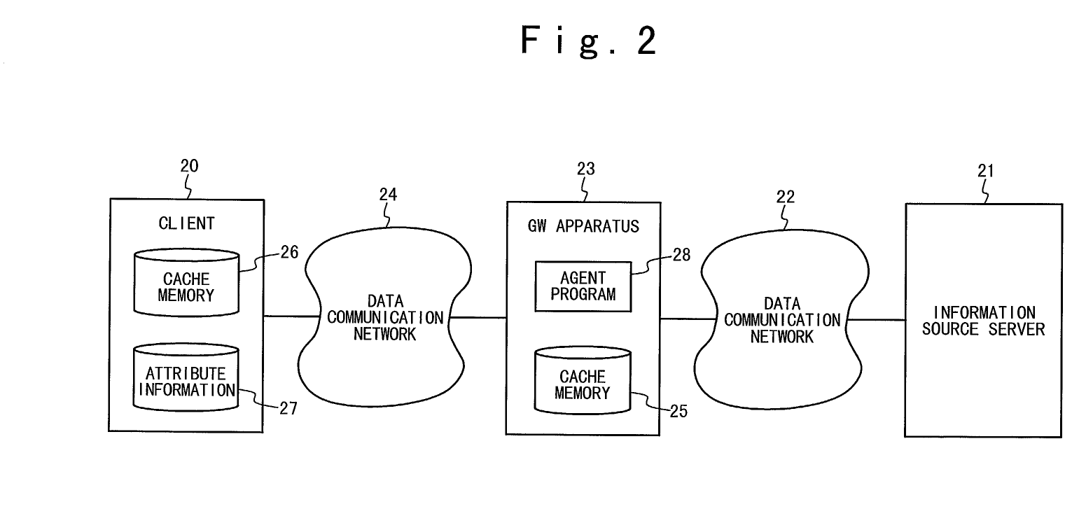

FIG. 2 shows a schematic configuration of an information providing system according to a first embodiment of the present invention. In this information providing system, a client 20 such as a personal computer, a portable telephone or the like, in order to access various information stored in an information source server 21 connected to the Internet, uses a GW apparatus 23 connected to this information source server 21 through a data communication network 22 through which a wire or wireless data communication can be done. The client 20 is connected to this GW apparatus 23 through a data communication network 24 through which a wire or wireless data communication can be done.

In order to absorb differences of a security manner of a communication data, a band width and a transmission delay amount between the data communication networks 22 and the data communication network 24 and reduce a load on the data communication network 22 as much as possible, the GW apparatus 23 has a cache memory 25, and transiently accumulates therein the information from the information source server 21 to which the client 20 requests an access.

The client 20 also has a cache memory 26, and tries to re-use previously acquired information (hereafter, referred to as “acquirement information”) in order to effectively use a communication resource. Moreover, the client 20 stores therein attribute information 27 composed of profile information and preference information, and re-configures the acquirement information accumulated in the cache memory 26 based on this attribute information 27. Thus, it is possible to provide information optimal for a user of the client.

The above-mentioned client 20 and the GW apparatus 23 respectively have a central processing unit (hereafter, abbreviated as CPU) (not shown), and can execute various controls in accordance with programs stored in predetermined memories such as a read only memory (ROM) and the like.

In the GW apparatus 23, an agent program 28 is stored in the predetermined memory, and suitably read out and executed by the CPU. The agent program 28 performs a control for changing information to be provided to the client 20, in accordance with a profile attribute of the client 20 sent by the client 20, communication attribute information of the data communication networks 22, 24, and a preference attribute of the user of the client 20.

The profile attributes of the client 20, for example, includes a capacity of a reception buffer of the client 20, its store remaining amount, a size of a display region, the number of bits for a display color, a battery remaining amount, an input manner and a processing ability. They are based on the CC/PP (Composite Capability/Preference Profile) specification defined by the World Wide Web Consortium (W3C) and the UAPROF (User Agent Profile) specification considered by the wireless application protocol forum (WAP Forum).

The communication attribute information of the data communication networks 22, 24, for example, includes transmission capacities of the data communication networks 22, 24, transmission delay amounts thereof and a transmission/reception profile such as a specification of half duplex or full duplex, a transmission/reception timing or the like.

The preference attribute of the user of the client 20, in order to represent a taste and a favorite of the user, for example, includes a kind and an access frequency of the information source server 21, an automatic process for defining an access timing and a access round of an information source server, and a filtering indication for indicating information to be cut out in accordance with a priority for the information and the like. Similarly, they are based on the above-mentioned specifications. The user of the client 20 can suitably change the profile attribute, the communication attribute information and the preference attribute.

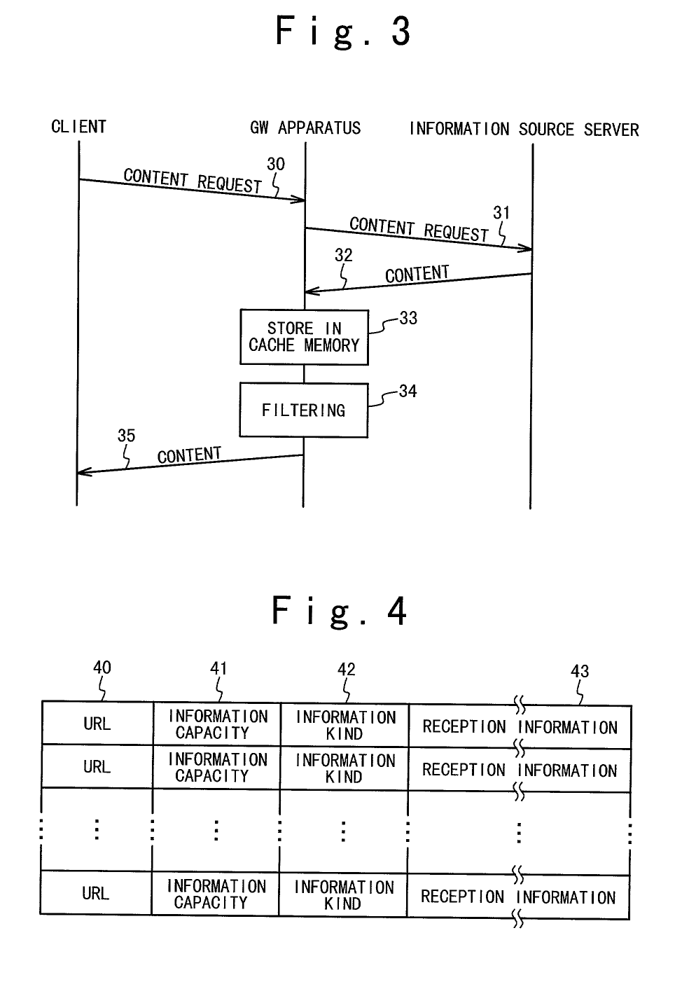

FIG. 3 schematically shows a series of information acquiring sequences of the information providing system in the first embodiment as mentioned above. The client 20, when receiving an address to specify an information source server 21 to be accessed from a user, sends a content request 30 including the received address through the data communication network 24 to the GW apparatus 23. The GW apparatus 23 stores this content request in the cache memory 25, and sends a content request 31 through the data communication network 22 to the information source server 21 to which the access is requested. At this time, in accordance with the profile attribute, the preference attribute and the communication attribute information of the data communication network, the GW apparatus 23 requests the information source server 21 to acquire the information such that a load on the data communication network is reduced by performing, for example, the access round on the information source server 21, and it becomes efficient for the communication ability of the client.

The information source server 21, in which the various contents are stored in advance, takes out a content which is requested to be acquired by the received content request 31, and returns it as a content 32 to the GW apparatus 23.

The GW apparatus 23, when receiving the content 32, stores it in the cache memory 25 as a content 32 made into the packet (Store 33), correspondingly to the content request 30 stored in the cache memory 25, prior to the reception. The GW apparatus 23 carries out a filtering process 34 by using the agent program 28, based on the preliminarily stored profile attribute information of the client 20, the communication attribute information of the data communication networks 22, 24 and the preference attribute information, and changes the content stored in the cache memory 25 to the information to be provided to the client 20. For example, in accordance with the process ability and the display ability of the client 20 and the taste of the user of the client 20, the GW apparatus 23 carries out the effective information provisions, such as a change of an information amount with color picture information as picture information corresponding to white/black picture information, a change of a quality of information with high quality picture information as low quality picture information, a change of a timing of information to be sent and the like. The information filtered on the basis of the agent program 28 in the GW apparatus 23 as mentioned above is sent as a content 35 to the client 20.

In the information providing system in the first embodiment of the present invention, the client 20 can further display the information received from the GW apparatus 23, for example, on a display (not shown), in a condition optimal for the user of the client, in accordance with the attribute information 27 composed of the profile information and the preference information. The client 20 that can carry out such a control will be described below.

In order to re-use the information such as the content received from the GW apparatus 23 and the like, the client 20 stores relation information such as an identifier of the information source server 21 and the like together with this received information, in the cache memory 26, and then retrieves this stored information every time the access to the information source server is occurred.

FIG. 4 shows the schematic configuration of the memory information of the above-mentioned cache memory 26. The cache memory 26 of the client 20, as an identifier of the information source server 21, stores therein information capacity 41 representing capacity of a reception information when the GW apparatus 23 previously accessed an information source server pointed out by a URL (Uniform Resource Locators) 40, correspondingly to the URL, for example, to be used on the Internet, an information kind 42 to identify figure information, character information or acoustic information, and its reception information 43.

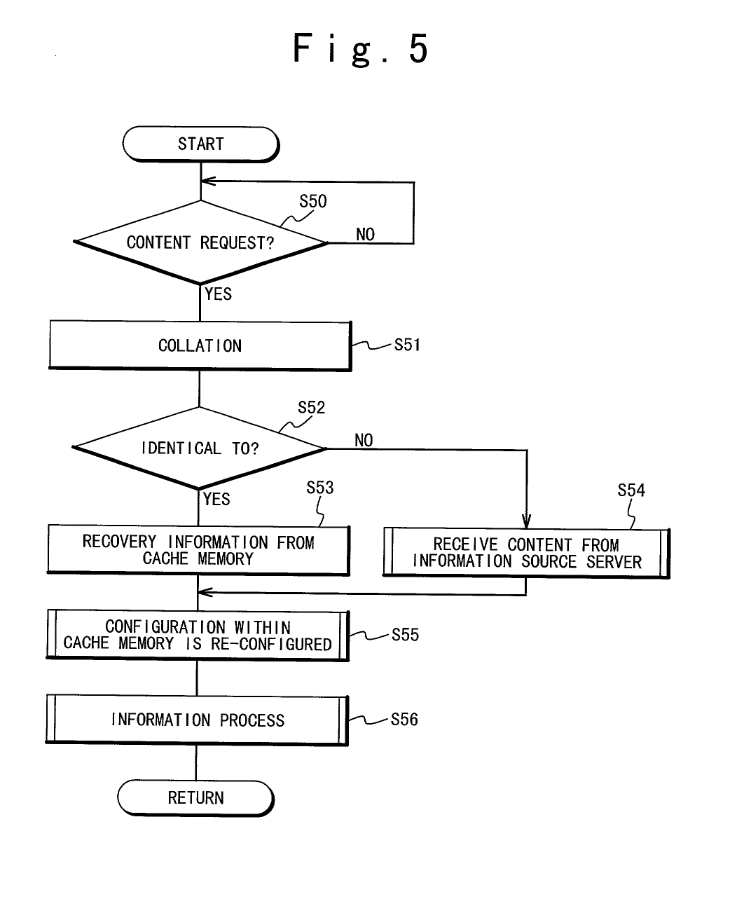

FIG. 5 shows an example of a process content of an information source server access process that is stored in a predetermined memory and processed by a CPU (not shown) in the client 20. That is, the client 20 monitors acquirement request i.e. a content request from the user to a content stored in a predetermined information source server on the Internet (Step S50: NO). If this content request is detected as an indication of an information source server of a request destination identified by the URL (Step S50: YES), the cache memory 26 is firstly accessed to refer to a previous access history.

That is, the client 20 accesses the cache memory 26, and performs collation by using a indicated URL as a retrieval key, and accordingly judges whether or not there is a content that was previously acquired by the same information source server and is identical to a content requested by the user at this time (Step S51). If it is judged that there is a coincident retrieval key as the collation result of the retrieval key (Step S52: YES), information stored correspondingly to the URL used as the retrieval key is taken out from the cache memory and recovered (Step S53). On the other hand, if it is judged that there is not the coincident retrieval key as the collation result of the retrieval key (Step S52: NO), a communication processor (not shown) carries out a communication connection through the data communication network 24 to the GW apparatus 23, and receives the content whose acquirement is requested from the information source server corresponding to the indicated URL (Step S54).

If the requested content is acquired from the cache memory 26 or the information source server as mentioned above, a configuration within the cache memory 26 is re-configured (Step S55). That is, the information to be accumulated in the cache memory 26 is arranged so as to provide the information optimal for the client 20 or its user, based on the profile information and the preference information stored in advance as the attribute information 27. After that, the predetermined information processes, such as a picture process, a display process and the like, are performed on the content acquired at the step S53 or S54 (Step S56). Then, the series of processes is ended (Return).

The above-mentioned control for re-configuring the information accumulated in the cache memory 26 of the client 20 will be described below after the explanation of the information to be accumulated in the cache memory 26.

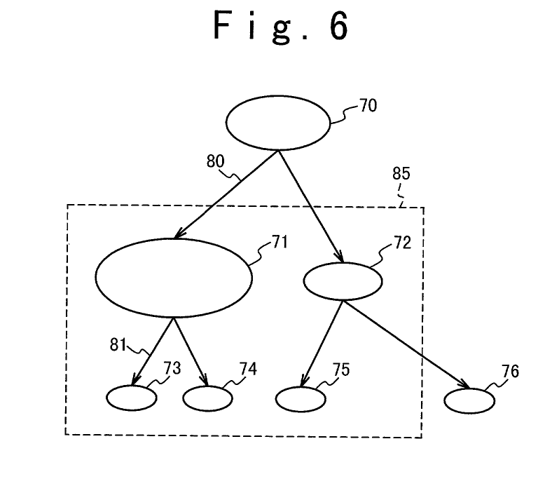

FIG. 6 conceptually shows the manner when the information received from the information source server 21 is accumulated in the cache memory 26 of the client 20. Here, information 70 to 76 indicate the respective information which are displayed on a display (not shown) of the client 20 and on which a predetermined receiving process is performed. An information amount is represented by a size of a figure. For example, it indicates that an information amount of the information 71 is greater than that of the information 73. Here, when each information is defined as menu data corresponding to one screen on the display (not shown) of the client 20, each information is correlated and linked to other information corresponding to one screen corresponding to a selection item of a menu screen. This link is denoted by an arrow for coupling each information, and a direction of the arrow is defined as a transition direction.

If the information 70 is assumed to be an initial menu data when a power supply of the client 20 is turned on or when the client 20 is initialized, the information 71 is menu data correlated by a link 80, correspondingly to one selection item on a menu screen based on the information 70. Moreover, the information 73 is menu data correlated by a link 81, correspondingly to one selection item on a menu screen based on the information 71.

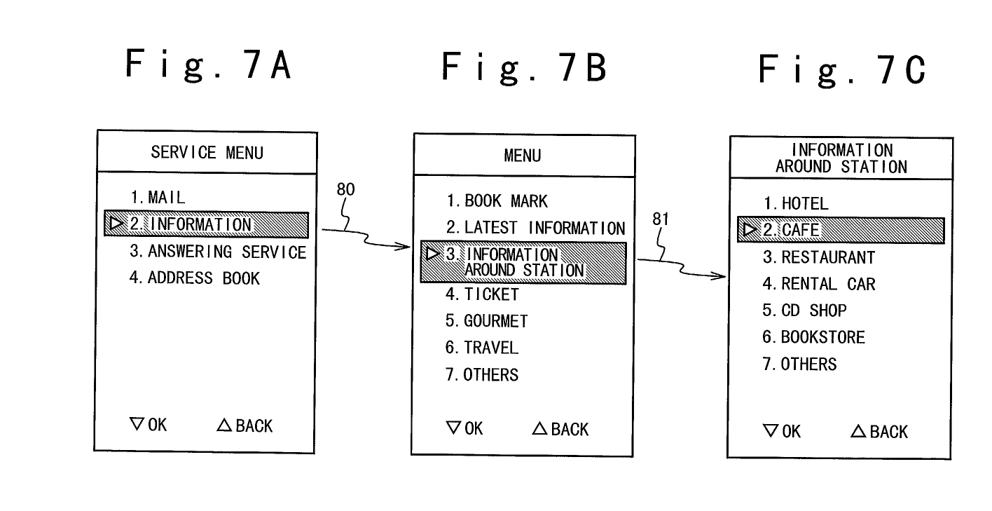

FIGS. 7A, 7B and 7C show examples of screen images displayed on the display (not shown) of the client 20. FIG. 7A shows an image of an initial menu screen displayed based on the information 70. FIG. 7B shows an image of a portal site screen displayed based on the information 71. Also, FIG. 7C shows an image of a service screen displayed based on the information 73. When the power supply of the client 20 is turned on or when it is initialized, the initial menu screen shown in FIG. 7A is displayed based on the information 70. Here, when a selection item “2. INFORMATION” is selected by using a cursor, the menu screen based on the information 71 correlated to it by the link 80 is displayed as shown in FIG. 7B. Moreover, when a selection item “3. INFORMATION AROUND STATION” is selected by using the cursor, the menu screen based on the information 73 correlated to it by the link 81 is displayed as shown in FIG. 7C.

The client 20 stores in advance the information 70, which is the initial menu data, in a non-volatile memory. So, the information of the menu screen selected by the user from the display screen of this initial menu data is sequentially acquired from the information source server. Thus, the client 20 can reduce the information amount to be stored to a minimum and always acquire the newest information that is changed occasionally and momentarily. At this time, the client 20 can avoid the re-access to the previously acquired menu data by accumulating as much as possible the menu data acquired for each selection from each menu screen, in the cache memory 26. Here, if an accumulation capacity of the cache memory 26 is within a dashed line range 85 of FIG. 6, the information 76 can not be accumulated. Hence, if the access to the information 76 is again done, it is necessary to connect through the data communication network 24 to the information source server.

The capacity of the cache memory 26 of the client 20 is limited as mentioned above. Thus, in the client 20 in the first embodiment of the present invention, the contents, which were previously accessed and accumulated in the cache memory 26, are suitably re-configured so as to effectively accumulate the information necessary for the client 20 or the user of the client 20, based on the attribute information 27.

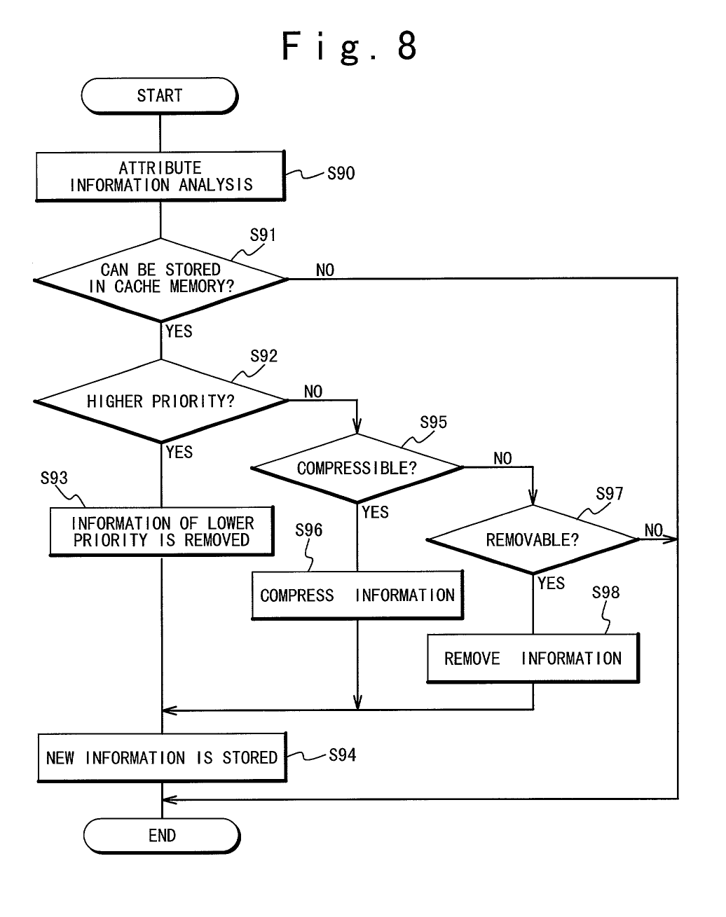

FIG. 8 shows an example of a process for reconfiguring the memory information in the cache memory 26 of the client 20 shown at the step S55 of FIG. 5. The client 20 firstly analyzes the profile information of the client 20 and the preference information of the user of the client 20 stored in advance as the attribute information 27 (Step S90).

That is, if the content is re-used at the step S53 of FIG. 5, the access frequency is updated, or a content is newly acquired at the step S54. Thus, a relation between information to be newly stored and information already stored in the cache memory 26 is analyzed based on the updated preference information and profile information. Then, a priority is added, or compressible accumulation information is retrieved, or removable accumulation information is retrieved. For example, a priority is added so as to store new reception information instead of accumulation information having a low access frequency. If its priority is low, a picture quality of picture information or a tone quality of acoustic information is dropped by referring to the profile information. Accordingly, it is possible to compress the accumulation information.

Also, if a unit of information accumulated in the cache memory 26 is menu data corresponding to one screen in the display (not shown) of the client 20, it is correlated to information corresponding to the screen corresponding to a selection item in each menu screen. The correlation between the respective information is changed by the re-configuration of the memory information. The correlation is an important element for determining the priority to be added at the time of the above-mentioned analysis and the removal possibility.

As an analyzed result of such attribute information 27, if it is judged that the information to be updated can be stored in the cache memory 26 (Step S91: YES), the priority added based on the analysis is firstly referred to. If the priority is higher than that of certain information (Step S92: YES), information of a lower priority is removed from the cache memory 26 (Step S93). Then, new information to be newly updated is stored in the cache memory 26 (Step S94). Then, a series of processes is ended (End).

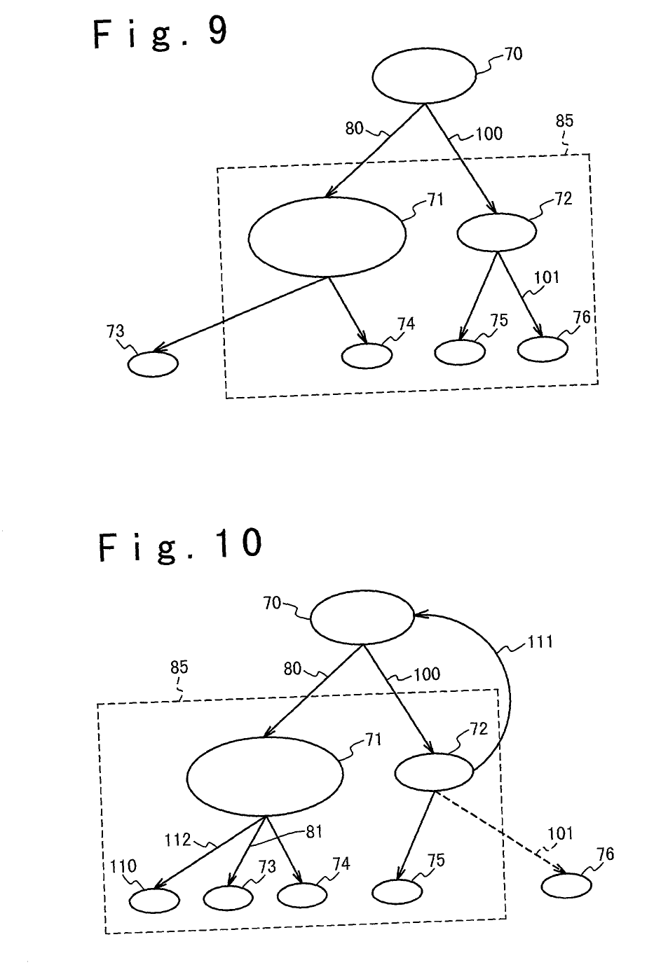

FIG. 9 conceptually shows an example of the manner performed at the steps S92, 93 when the information received from the information source server 21 is stored in the cache memory 26 of the client 20. If it is judged that the acquirement of the information 76 is higher in priority than that of the information 73 based on the taste of the user as the analyzed result of the preference information among the attribute information 27, the information 73 is removed from the cache memory 26, and the information 76 is stored instead of it. After that, a link 101 is established between the information 76 and the information 72 already correlated to the information 70 by a link 100, and the link to the removed information 73 is deleted.

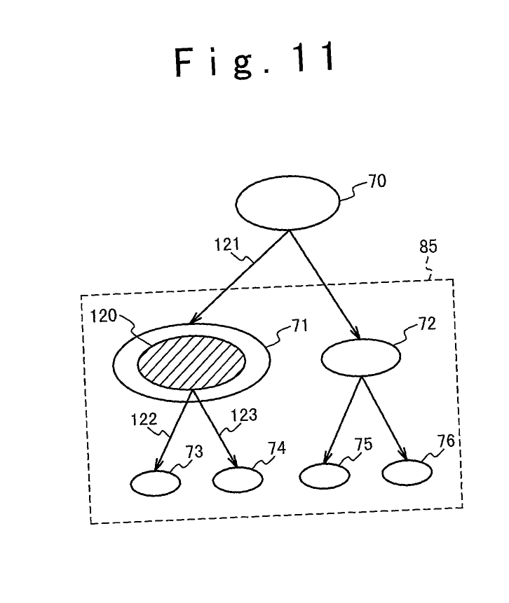

FIG. 10 conceptually shows another example of the manner performed at the steps S92, 93 when the information received from the information source server 21 is stored in the cache memory 26 of the client 20. If it is judged that the acquirement of an information 110 is higher in priority than that of the information 76 based on the taste of the user as the analyzed result of the preference information among the attribute information 27, a link 111 to return to the information 70 is generated instead of the link 101 to the information 76. The information 76 is removed from the cache memory 26, and the information 110 is stored. After that, a link 112 is established between the information 110 and the information 71 already correlated to the information 70 by the link 80.

By returning to FIG. 8, the explanation is continued. At the step S92, as the analyzed result of the attribute information 27, if the added priority is lower than that of other information (Step S92: NO), in accordance with the profile information of the client 20, by referring to the information kind and the information capacity correlated to the accumulation information as shown in FIG. 4, it is judged whether or not there is a component which can compress by dropping the picture quality of the picture information or the tone quality of the acoustic information in the already stored accumulation information (Step S95). At this Step S95, if it is judged that there is the compressible component (Step S95: YES), the accumulation information is compressed, for example, by changing the picture quality and/or the size of the picture information and/or dropping the tone quality of the acoustic information (Step S96). After that, new information to be newly updated is stored in the cache memory 26 (Step S94). Then, the series of processes is ended (End).

FIG. 11 conceptually shows an example of the manner when the information received from the information source server 21 is compressed in the cache memory 26 of the client 20 at the step S96. That is, by referring to the information kind and the information capacity correlated to the accumulation information as shown in FIG. 4 among the information already accumulated in the cache memory 26, if it is judged that the information 71 is the compressible information, for example, if the client 20 includes picture information of a color picture although the client 20 has only a display performance of a white/black picture, the information 71 is compressed into information 120 by carrying out a subtractive color process of the color picture, or changing the picture quality itself or a size, or dropping the tone quality of the acoustic information. Then, a link 121 from the information 70 and links 122, 123 to the information 73, 74 are again generated, which increases a memory region for new information in the cache memory 26.

Again, by returning to FIG. 8, the explanation is continued. If it is judged at the step S95 that there is no compressible information (Step S95: NO), it is then judged whether or not there is information that can be removed based on the access frequency of the preference information and the profile information of the client 20 and the like (Step S97). If there is the removable information (Step S97: YES), its information is removed (Step S98). Then, new information to be newly updated is stored in the cache memory 26 (Step S94). Then, the series of processes is ended (End).

On the other hand, as the analyzed result of the attribute information 27 at the step S91, if it is judged that the information to be updated can not be stored in the cache memory 26 (Step S91: NO), or if it is judged that there is not the information which can be removed at the step S97 (Step S97: NO), the series of processes is directly ended (End). In this case, it is necessary that the information to be newly stored is acquired through the data communication network 24 from the information source server, even if a re-access is tried.

As mentioned above, in the information providing system according to the first embodiment of the present invention, the client 20 requesting the acquirement of the various information stored in the information source server 21 receives, through the GW apparatus 23, the acquirement information from the information source server 21 transiently stored in the cache memory 25 based on the agent program 28 of this GW apparatus 23, in accordance with the profile information of the client 20, the preference information of its user and the communication attribute information of the data communication network, while effectively using the data communication network by automatically making a round and periodically acquiring. The client 20 stores the reception information from the GW apparatus 23 in the cache memory 26, and again configures the accumulation information for each access by considering the relation to the stored information based on the attribute information 27. Thus, it is possible to omit the useless usage of the communication network and also possible to provide an operation menu that is easy for the client 20 and the user of the client 20 to access even if it is not connected to the data communication network. Moreover, the capacity of the cache memory 26 of the client 20 can be effectively used, which can reduce the capacity of the cache memory to a minimum and can attain a low consumptive power and a miniaturization and further improve the portability.

(Second Embodiment)

The information providing system according to the first embodiment of the present invention is designed such that the GW apparatus 23 acquires the information requested by the client 20 from the information source server 21 at the optimal communication amount, in accordance with the preference information, the profile information and the communication attribute information. However, it is not limited to that configuration. In an information providing system according to a second embodiment of the present invention, the client 20 reports the preference information, the profile information and the communication attribute information to the information source server. Then, the information source server sends store information whose acquirement is requested by the client to the GW apparatus 23, in accordance with those attribute information.

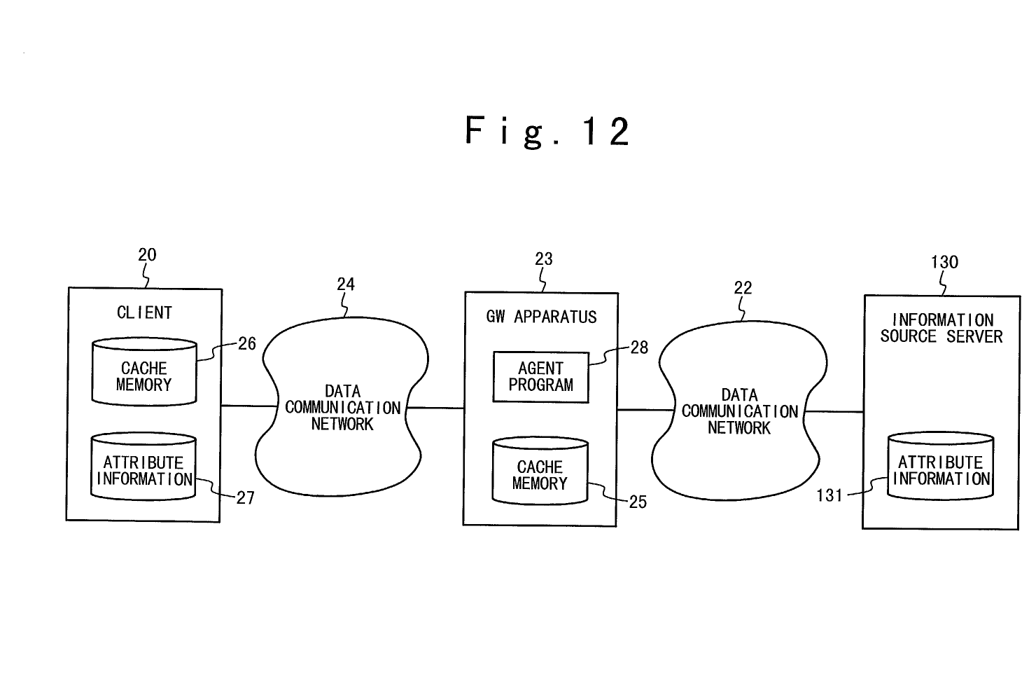

FIG. 12 shows a schematic configuration of the information providing system according to the second embodiment of the present invention. In the information providing system shown in FIG. 12, the same symbols are given to the same portions as the information providing system according to the first embodiment of the present invention shown in FIG. 2, and their explanations are omitted. The information providing system in the second embodiment differs from that of the first embodiment in that an information source server 130 for storing therein information whose acquirement is requested by the client 20 stores therein attribute information 131 which is sent by this client 20 and similar to the attribute information 27, and an information provider can effectively provide the information at a transmission timing, a quality and an information amount optimal for a taste of a user, a display ability and a process ability of the client, in accordance with this attribute information 131.

In this case, the side of the information provider can total various tendencies required to effectively provide the information of the process ability and the display ability of the client using the information providing service and the taste of the user. For example, this enables not only a grasp of advertisement effect but also an information providing service in which the information provider reports to a sponsor the time close to an actual time of the advertisement effect and it is not attained in the conventional technique. Thus, for example, the sponsor can analyze its advertisement effect to thereby determine the most effective advertisement method.

It should be noted that, in the first and second embodiments, the profile information and the preference information are set in advance for the client. Thus, it is possible to reduce an economic burden on the user and a load on the communication network. For example, information optimal for a buyer can be acquired quickly and effectively by selling a client in which a manufacture defines attribute information of a combination of preference information and profile information preliminarily determined in accordance with a usage tendency of a user such as “Setting As Business Terminal” or “Setting As Terminal For Sports Fan”. Moreover, a client convenient for a user can be provided by selling the attribute information itself corresponding to this usage tendency and enabling the user to set it to the client. Moreover, it is possible to introduce a feature in order to enlarge a sales network of the client.

Moreover, in the first and second embodiments, it is desirable to perform a proper encryption and a user verification on the profile information of the client and the preference information of the user, from the viewpoint of privacy, when those attribute information are disclosed for the communication network, the GW apparatus and the information source server.

Furthermore, the information providing system according to those embodiments is configured such that the client is connected to only one information source server through the wireless data communication network. However, it is not limited to this configuration. So, the similar effect can be attained even in a case of a connection in which a plurality of information source servers can access such as the Internet. Also, the similar effect can be attained even in a case that the client and the GW apparatus are integrated into a single device.

Furthermore, not only the client in the first embodiment but also the user itself of the client in the second embodiment can indicate the priority of the particular preference information or transiently operate the profile information to thereby improve the efficiency of acquiring the information from the information source server. Moreover, by reporting this indicated attribute information to the GW apparatus and the information source server at any time, the data communication network can be effectively used between those respective apparatuses. Also, the above-mentioned dynamic switching between the attribute information enables the optimal acquirement of the information even if the client is changed depending on the purpose of the user. Thus, this implies the effective usage of the information source server.

As mentioned above, according to the present invention, the useless usage of the communication network is omitted and even if it is not connected to the data communication network, the information convenient for the client apparatus and its user can be provided.

Also, according to the present invention is composed such that the gateway apparatus is inserted between the information source server and the client apparatus, and the information provided by the information source server is acquired and transferred based on the communication attribute information of the first and second data communication networks between the client apparatus and the information source server and the attribute information through this gateway apparatus. Thus, it is possible to make each data communication network effective and reduce the load of the client apparatus. Hence, even if the process ability of the client apparatus is low, it is possible to provide the client apparatus convenient for the user.

Moreover, according to the present invention, the side of the information provision can total the various tendencies required to effectively provide the information of the process ability and the display ability of the client apparatus using the information providing service and the taste of the user. For example, this enables not only the grasp of the advertisement effect but also the information providing service in which the information provider reports to the sponsor the time close to the actual time of the advertisement. Thus, the sponsor can analyze its advertisement effect to thereby determine the most effective advertisement method.

Moreover, according to the present invention, the client apparatus can dynamically change the respective attribute information. Thus, for example, the client apparatus can transiently operate the profile information or the communication attribute information to thereby improve the efficiency of acquiring the information from the information source server. Moreover, if this changed attribute information is suitably reported to the gateway apparatus or the information source server, the first and second data communication networks or the data communication networks can be effectively used between those respective apparatuses. Also, the above-mentioned dynamic switching between the attribute information enables the optimal information to be acquired even if the client apparatus is changed depending on the purpose of the user of the client apparatus. Thus, this implies the effective usage of the information source server.

Moreover, according to the present invention, the capacity of the cache memory of the client apparatus can be effectively used to thereby reduce its capacity to a minimum and attain the low consumptive power and the miniaturization and accordingly improve the portability.

Moreover, according to the present invention, it can be applied to a WAP system.

m Moreover, according to the present invention, by carrying out the particular setting, for example, such as “Setting As Business Terminal” or “Setting As Terminal For Sports Fan”, the user suitable for this setting can acquire the information of the content at the optimal condition immediately after the start of the usage and the like. Hence, it is possible to reduce the economic burden on the user and the load on the communication network.

Moreover, according to the present invention, it is possible to provide the client apparatus convenient for the user of the client apparatus and also possible to introduce the feature in order to enlarge the sales network of the client apparatus.

What is claimed is:

1. A client apparatus comprising:
a cache memory which accumulates information externally provided;
an accumulation judgment portion which judges whether or not the information to be externally provided is accumulated in said cache memory;
a request portion which requests acquirement of information when said accumulation judgment portion judges that the information to be externally provided is not accumulated in said cache memory; and
an information processor which processes either one of the information accumulated in said cache memory and the information externally provided in response to the request from said request portion.

2. The client apparatus according to claim 1, further comprising:
a storage judgment portion which judges whether or not the information externally provided can be stored in said cache memory;
an information reduction portion which reduces an amount of the information accumulated in said cache memory based on attribute information composed of preference information of a user and profile information indicative of a process ability of said client apparatus when said storage judgment portion judges that the information externally provided can not be stored in said cache memory; and
a control portion which controls said cache memory such that the information externally provided in response to the request from said request portion is stored after the amount of the information is reduced by said information reduction portion.

3. An information providing system comprising:
an information source server which provides information in response to a request;
a client apparatus; and
a data communication network which connects said client apparatus to said information source server,
wherein said client apparatus includes:
a cache memory which accumulates the information provided by said information source server;
an accumulation judgment portion which judges whether or not the information to be provided by said information source server is accumulated in said cache memory;
a request portion which requests acquirement of the information to said information source server through said data communication network when said accumulation judgment portion judges that the information to be provided by said information source server is not accumulated; and
an information processor processes either one of the information accumulated in said cache memory and the information provided by said information source server in response to the request from said request portion.

4. The information providing system according to claim 3, further includes:
a storage judgment portion which judges whether or not the information provided by said information source server can be stored in said cache memory;
an information reduction portion which reduces the amount of the information accumulated in said cache memory based on attribute information composed of preference information of a user and profile information indicative of a process ability of said client apparatus when said storage judgment portion judges that the information provided by said information source server can not be stored in said cache memory; and
a control portion which controls said cache memory such that the information provided by said information source server in response to the request from said request portion is stored after the amount of the information is reduced by said information reduction portion.

5. The information providing system according to claim 4, wherein said data communication network comprises:
a gateway apparatus which is connected to said client apparatus through a first data communication network and connected to said information source server through a second data communication network,
wherein said gateway apparatus includes:
a second request portion which requests acquirement of the information to said information source server through said second data communication network with said attribute information and communication attribute information indicative of communication abilities of said first data communication network and said second data communication network when the request of said request portion of said client apparatus is received through said first data communication network;
a second cache memory which accumulates the information provided by said information source server in response to the request from said second request portion; and
a transfer portion which transfers the information accumulated in said second cache memory to said client apparatus through said first data communication network based on said attribute information and said communication attribute information.

6. The information providing system according to claim 5, wherein said information source server provides the information to said gateway apparatus based on said attribute information and said communication attribute information in response to the request from said second request portion.

7. The information providing system according to claim 6, wherein said gateway apparatus provides the information to said client apparatus based on said attribute information and said communication attribute information in response to the request from said request portion.

8. The information providing system according to claims 7, wherein said client apparatus further includes an attribute information change portion in which at least one of said attribute information and said communication attribute information is dynamically changed.

9. The information providing system according to claims 8, wherein said information reduction portion removes the information having a low priority from said cache memory, wherein the priority is determined based on said attribute information.

10. The information providing system according to claims 9, wherein said information reduction portion compresses the information stored in said cache memory based on said attribute information.

11. The information providing system according to claims 10, wherein the information provided by said information source server includes menu data for selecting an item and is linked to other information corresponding to other menu data, the other information being provided by said information source server based on the selected item, and
said control portion controls said cache memory such that a remaining capacity of said cache memory is increased by changing the link generated between the menu data and the other menu data, every time one of the menu data and the other menu data is stored in said cache memory.

12. The information providing system according to claims 11, wherein said attribute information used in said client apparatus is prepared for each predetermined usage tendency.

13. The information providing system according to claim 12, wherein said attribute information used in said client apparatus can be changed into other attribute information having another predetermined usage tendency.

14. An information providing method comprising:
(1) providing an information source server and a client apparatus;
(2) accumulating information provided by said information source server in a cache memory;
(3) judging whether or not the information to be provided by said information source server is accumulated in said cache memory;
(4) requesting acquirement of the information to said information source server when said judging step (3) judges that the information to be provided by said information source server is not accumulated in said cache memory; and
(5) processing either one of the information accumulated in said cache memory and the information provided by said information source server in response to the request.

15. The information providing method according to claim 14, further comprising:
(6) judging whether or not the information provided by said information source server can be stored in said cache memory;
(7) reducing the amount of the information accumulated in said cache memory based on attribute information composed of preference information of a user and profile information indicative of a process ability of said client apparatus when said judging step (6) judges that the information provided by said information source server can not be stored in said cache memory; and
(8) controlling said cache memory such that the information provided by said information source server in response to the request is stored after the amount of the information is reduced by said reducing step.

16. The information providing method according to claim 15, further comprising:
(9) providing a gateway apparatus which is connected to said client apparatus through a first data communication network and connected to said information source server through a second data communication network;
(10) requesting acquirement of the information to said information source server through said second data communication network with said attribute information and communication attribute information indicative of communication abilities of said first data communication network and said second data communication network when the request of said requesting step (4) is received through said first data communication network;
(11) accumulating the information provided by said information source server into a second cache memory in response to the request in said requesting step (10); and
(12) transferring the information accumulated in said second cache memory to said client apparatus through said first data communication network based on said attribute information and said communication attribute information.

17. The information providing method according to claim 16, wherein said information source server provides the information to said gateway apparatus based on said attribute information and said communication attribute information in response to the request in said requesting step (10).

18. The information providing method according to claim 17, wherein said gateway apparatus provides the information to said client apparatus based on said attribute information and said communication attribute information in response to the request in said requesting step (4).

19. The information providing method according to claims 18, wherein said reducing step (7) removes the information having a low priority from said cache memory, wherein the priority is determined based on said attribute information.

20. The information providing method according to claims 19, wherein said reducing step (7) compresses the information stored in said cache memory based on said attribute information.
